(19) United States
(12) Patent Application Publication
(10) Pub. No.: US 2016/0044654 A1
(43) Pub. Date: Feb. 11, 2016

(54) METHOD AND APPARATUS FOR REDUCING UPLINK TRANSMISSIONS

(71) Applicant: NOKIA TECHNOLOGIES OY, Espoo (FI)

(72) Inventors: Lars DALSGAARD, Oulu (FI); Ilkka KESKITALO, Oulu (FI); Jussi-Pekka KOSKINEN, Oulu (FI)

(21) Appl. No.: 14/779,406

(22) PCT Filed: Mar. 18, 2014
(86) PCT No.: PCT/FI2014/050200

§ 371 Date: Sep. 23, 2015

Related U.S. Application Data
(60) Provisional application No. 61/805,363, filed on Mar. 26, 2013.

(51) Int. Cl. H04W 72/04; H04W 76/04

(52) U.S. Cl. CPC H04W 72/0413; H04W 76/048

(57) ABSTRACT

Various methods are provided for reducing uplink transmissions. One example method may comprise causing operation of use equipment in a uplink synchronized state, wherein updates are received periodically in a on duration period, on duration periods are related to discontinuous reception (DRX) short cycle timer, receiving instruction to disable uplink transmission during one or more on duration periods related to short cycle timer of DRX, and causing disablement of uplink transmission in accordance with instruction.

### TECHNOLOGICAL FIELD

Embodiments of the present invention relate generally to a method, apparatus, and computer program product for facilitating the reduction of uplink transmissions.

### BACKGROUND

Wireless communication is becoming more widespread as a continually increasing number of users acquire and place into operation ever-greater numbers of mobile communication devices. Along with this increase in number of mobile devices there is an increase in the amount of time the mobile devices are in use. This places an ever-increasing demand on the amount of time mobile devices are able to provide functionality between rechargings or repowerings.

The need for longer periods of usability becomes even more apparent as more functionality is incorporated into mobile communication devices. For example, many mobile communication devices now include Personal Information Management (PIM), or a camera, music player (MP3 or the like), or gaming functionality in addition to their communication capabilities. Therefore these devices are potentially in use even when the user is not using the communication capabilities of the device. This additional functionality places further demands on the power reserves of the mobile device.

Currently, one of the most effective methods of conserving power, and thereby extending the amount of time the device can be used, is enabling a power saving mode that turns off the screen of the mobile device and modifies behavior of web applications accordingly. The problem with this approach is that it also reduces the effectiveness of the mobile device. For example, smart phones typically have applications that require ‘always-on’-type of connections. Such applications generate traffic also during times when the user does not actively use the terminal and the application. In such case, for the sake of saving power, it is desirable to either configure the user equipment (UE) with Discontinuous Reception (DRX) or release the connection between the data transmissions. DRX configuration and the decision about the connection release may be done by the access network.

Connected mode DRX may provide efficient means to reduce, such as minimizing, the activity on the UE side with regard to the downlink (DL) reception as well as to some extend the uplink (UL) activity. However, UE UL transmission contributes a significant share of the overall UE power consumption while in non-active mode e.g. when there is only background traffic ongoing. When the UE has been configured for short DRX, in order to wait/be ready for possible further data transmission, the UE may send UL channel quality Indicator (CQI)/(pre-coding matrix indicator (PMI) (CQI/CSI) information while UL timing is valid (TAT has not expired) including on-durations during the short DRX period until TAT is expired or connection is released. This wastes unnecessarily UE power resulting in shortened stand-by times of the terminal. Additionally it increases the UL interference.

Although the problem outlined here is general, it is especially of importance in those situations where the UE is in background mode. It is predicted that in the future more and more smart devices will be always online and in background mode where it is expected that such UE will generate a continuous amount of small data packet transfers with high frequency. In this kind of mode the present problem will have rather large impact e.g. on the UE power consumption.

Consequently, a need exists for a method of power management on mobile communication devices that not only reduces the power consumption of the device, but also retains the functionality of the device.

### BRIEF SUMMARY

A method, apparatus and computer program product are therefore provided according to an example embodiment of the present invention for the reduction of uplink transmissions. An example method may provide increased UE power saving opportunities by reducing the periodic UL signaling when the UL signaling is determined to be unnecessary, e.g. for those cases where the network and/or UE is sending small packages.

In accordance with one embodiment of the present invention, a method may be provided comprising causing operation of use equipment in a uplink synchronized state, wherein updates are received periodically in a on duration period, on duration periods are related to discontinuous reception (DRX) short cycle timer, receiving instruction to disable uplink transmission during one or more on duration periods related to short cycle timer of DRX, and causing disablement of uplink transmission in accordance with instruction.

In one embodiment, instruction may comprise a Radio Resource Control (RRC) message to configure a Physical Uplink Control Channel (PUCCH) where Uplink (UL) is enabled or disabled. In another embodiment, instruction may comprise a Medium Access Control (MAC) command comprising information related to an allowance or disallowance of UL communication disablement or reduction. In another embodiment, instruction may comprise a trigger command comprising information related to an allowance or disallowance of UL communication disablement or reduction. In one embodiment, instruction may comprise causing enabling or disabling of UL communication in a time limited manner. In one embodiment, a timer value shall be configured. In another embodiment, a timer value or time period can be fixed and defined in the specifications.

In accordance with another example embodiment of the present invention, an apparatus may be provided. The apparatus may comprise at least one processor and at least one memory including computer program code, the at least one memory and the computer program code configured to, with the processor, cause the apparatus to at least cause operation of use equipment in a uplink synchronized state, wherein updates are received periodically in a on duration period, on duration periods are related to discontinuous reception (DRX) short cycle timer, receive instruction to disable uplink transmission during one or more on duration periods related to short cycle timer of DRX, and cause disablement of uplink transmission in accordance with instruction.

In one embodiment, instruction may comprise a Radio Resource Control (RRC) message to configure a Physical Uplink Control Channel (PUCCH) where Uplink (UL) is enabled or disabled. In another embodiment, instruction may comprise a Medium Access Control (MAC) command comprising information related to an allowance or disallowance of UL communication disablement or reduction. In another embodiment, instruction may comprise a trigger command comprising information related to an allowance or disallowance of UL communication disablement or reduction. In one embodiment, instruction may comprise causing enabling or disabling of UL communication in a time limited manner. In one embodiment, a timer value shall be configured. In another embodiment, a timer value or time period can be fixed and defined in the specifications.

In accordance with another embodiment of the present invention, a computer program product may be provided. The computer program product may comprise at least one non-transitory computer-readable storage medium having computer-executable program code portions stored therein, the computer-executable program code portions comprising program code instructions for causing operation of use equipment in a uplink synchronized state, wherein updates are received periodically in a on duration period, on duration periods are related to discontinuous reception (DRX) short cycle timer, receiving instruction to disable uplink transmission during one or more on duration periods related to short cycle timer of DRX, and causing disablement of uplink transmission in accordance with instruction.

In one embodiment, instruction may comprise a Radio Resource Control (RRC) message to configure a Physical Uplink Control Channel (PUCCH) where Uplink (UL) is enabled or disabled. In another embodiment, instruction may comprise a Medium Access Control (MAC) command comprising information related to an allowance or disallowance of UL communication disablement or reduction. In another embodiment, instruction may comprise a trigger command comprising information related to an allowance or disallowance of UL communication disablement or reduction. In one embodiment, instruction may comprise causing enabling or disabling of UL communication in a time limited manner. In one embodiment, a timer value shall be configured. In another embodiment, a timer value or time period can be fixed and defined in the specifications.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is block diagram of a system that may be specifically configured in accordance with an example embodiment of the present invention;

FIG. 2 is a block diagram of an apparatus that may be specifically configured in accordance with an example embodiment of the present invention;

FIG. 3 is an example flowchart illustrating a method of operating an example apparatus in accordance with an embodiment of the present invention.

FIG. 4 is an example flowchart illustrating a method of operating an example apparatus in accordance with an embodiment of the present invention;

FIG. 5A-5B show exemplary timing diagrams, in accordance with an embodiment of the present invention;

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or application specific integrated circuit for a mobile phone or a similar integrated circuit in a server, a cellular network device, or other network device.

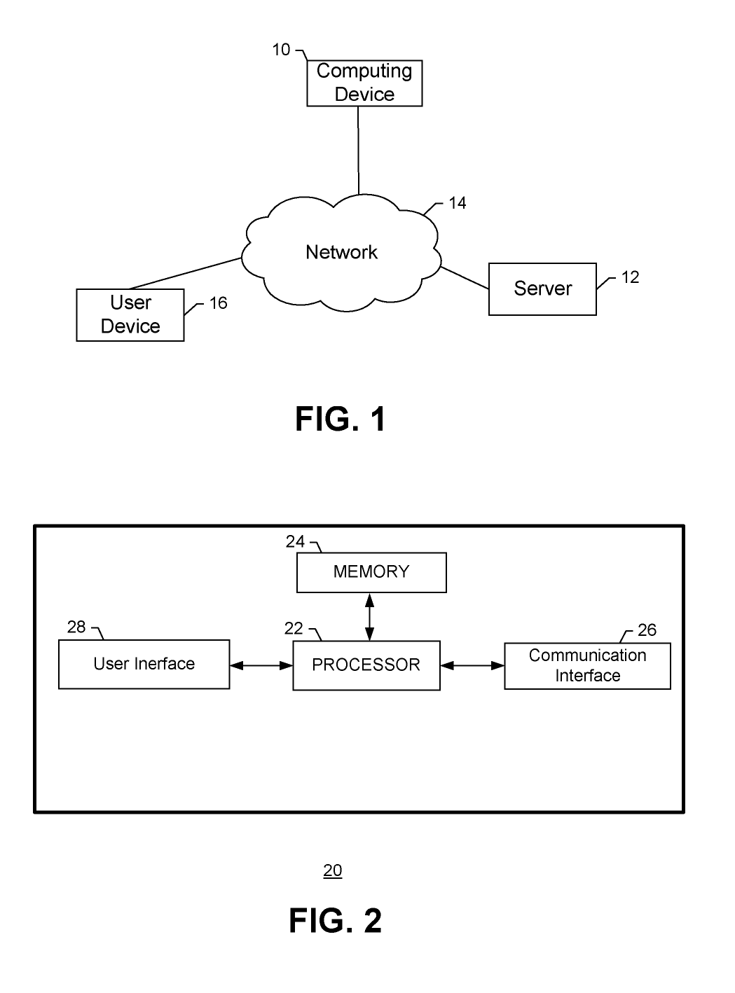

Referring now of FIG. 1, a system that supports communication, either wirelessly or via a wireline, between a computing device 10 and a server 12 or other network entity (hereinafter generically referenced as a “server”) is illustrated. As shown, the computing device and the server may be in communication via a network 14, such as a wide area network, such as a cellular network or the Internet or a local area network. However, the computing device and the server may be in communication in other manners, such as via direct communications between the computing device and the server.

The computing device 10 may be embodied by a number of different devices including mobile computing devices, such as a personal digital assistant (PDA), mobile telephone, smartphone, laptop computer, tablet computer, or any combination of the aforementioned, and other types of voice and text communications systems. Alternatively, the computing device may be a fixed computing device, such as a personal computer, a computer workstation or the like. The server 12 may also be embodied by a computing device and, in one embodiment, is embodied by a web server. Additionally, while the system of FIG. 1 depicts a single server, the server may be comprised of a plurality of servers which may collaborate to support browsing activity conducted by the computing device.

Regardless of the type of device that embodies the computing device 10, the computing device may include or be associated with an apparatus 20 as shown in FIG. 2. In this regard, the apparatus may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or or disabling of UL communication in a time limited manner.

In some embodiments, the processor 22 (and/or co-processors or any other processing circuitry assisting or otherwise associated with the processor) may be in communication with the memory device 24 via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 20 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device 10 configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In one embodiment, the processor may also include user interface circuitry configured to control at least some functions of one or more elements of the user interface 28.

Meanwhile, the communication interface 26 may be any means such as a device or circuitry embodied in either hardware or a combination of hardware and software that is configured to receive and/or transmit data between the computing device 10 and a server 12. In this regard, the communication interface 26 may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). For example, the communications interface may be configured to communicate wirelessly with the head mounted displays 10, such as via Wi-Fi, Bluetooth or other wireless communications techniques. In some instances, the communication interface may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of the computing device.

The user interface 28 may be in communication with the processor 22, such as the user interface circuitry, to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface may also be in communication with the memory 24 and/or the communication interface 26, such as via a bus.

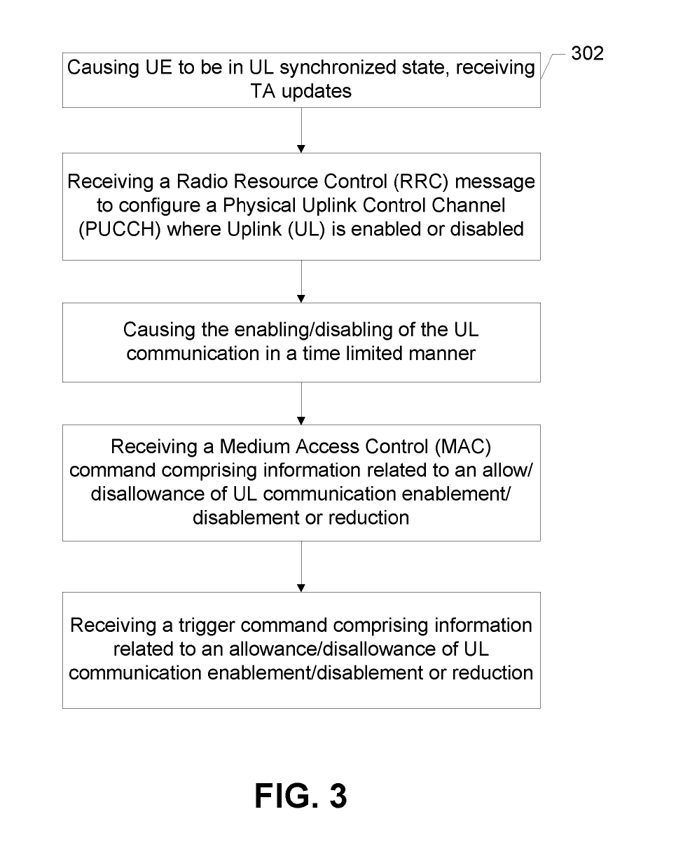

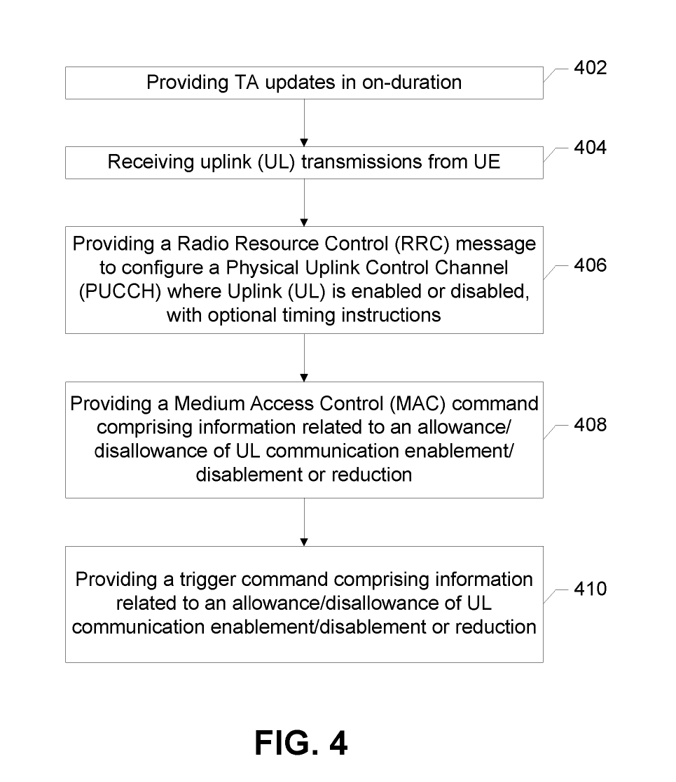

FIGS. 3 and 4 illustrate an example flowchart of the example operations performed by a method, apparatus and computer program product in accordance with an embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 3 and 4, when executed, convert a computer or processing circuitry into a particular machine configured to perform an example embodiment of the present invention. Accordingly, the operations of FIGS. 3 and 4 define an algorithm for configuring a computer or processing to perform an example embodiment. In some cases, a general purpose computer may be provided with an instance of the processor which performs the algorithms of FIGS. 3 and 4 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein.

In some example embodiments, a method, apparatus and computer program product is configured such that UL transmissions (e.g. channel quality Indicator (CQI)/(pre-coding matrix indicator (PMI)/Rank Indicator (RI)/Procedure Transaction Identifier (PTI) (CQI/PMI/RI/PTI) reports on PUCCH and/or type-0-triggered Sounding Reference Signal (SRS) transmissions are stopped during the DRX while the shortDRX-Cycle timer is running. This may also be done during DRX on-duration periods, i.e. UL transmissions are not performed when in on-durations related to short DRX timer. Additional configurations for PUCCH usage may include (1) Disabling/enabling the UL transmissions in connection with on-durations while is shortDRX-Cycle running and (2) Disabling by default the UL transmission in connection with on-duration while is shortDRX-Cycle running, but enabling the UL transmission with separate configuration or command. An example method may provide the network with methods to increase the UE power saving opportunities by reducing the periodic UL signaling when this UL signaling is seen unnecessary, e.g., for those cases where the network and/or UE is sending small packages.

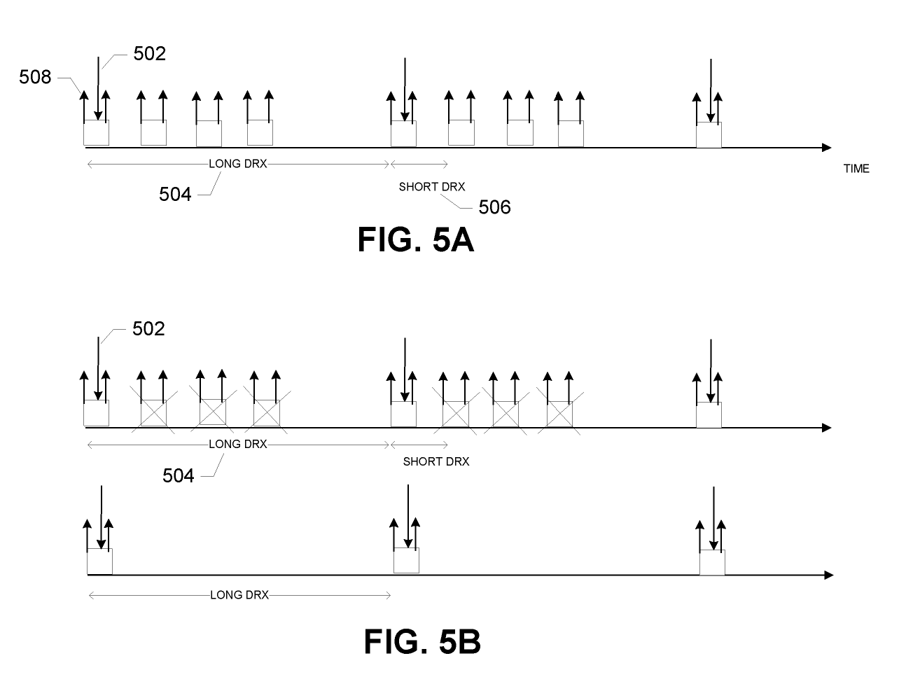

FIG. 3 is an example flowchart illustrating a method of reducing or minimizing UL transmissions in accordance with an embodiment of the present invention. As shown in block 302 of FIG. 3, the apparatus 20 embodied by the computing device 10 may therefore be configured to cause UE to operate in an UL synchronized state. The apparatus embodied by the computing device therefore includes means, such as the processor 22, the communication interface 26 or the like, for causing an UE to operate in an UL synchronized state. FIG. 5A shows UE operating in a synchronized state. UE receives TA updates 502. Operation in a synchronized state may therefore cause UE to receive data (e.g., Timing Advance (TA) updates) periodically (e.g., LONG DRX 504) in on-duration. The TA update may trigger short DRX 506 and further on-durations, triggering further UL activity 508 from UE side.

As shown in block 304 of FIG. 3, the apparatus 20 embodied by the computing device 10 may be configured to receive a Radio Resource Control (RRC) message to configure a Physical Uplink Control Channel (PUCCH) indicating an enablement or disablement of UL transmission. The apparatus embodied by the computing device therefore includes means, such as the processor 22, the communication interface 26 or the like, for receiving a RRC message to configure a Physical PUCCH indicating an enablement or disablement of UL transmission.

FIG. 5B shows an exemplary timing diagram of a UE operating in accordance with a method of restricting the UL activity from UE by removing UL transmissions 508 in on-durations related to short DRX 506 periods.

As shown in block 306 of FIG. 3, the apparatus 20 embodied by the computing device 10 may be configured to cause the enabling/disabling of the UL communication in a time limited manner. The apparatus embodied by the computing device therefore includes means, such as the processor 22, the communication interface 26 or the like, for causing the enabling/disabling of the UL communication in a time limited manner. In one embodiment, the enabling/disabling may be time limited, such that a timer value may be configured. In another embodiment, the timer value (or time period) may be fixed and defined in the specifications.

In another embodiment, as shown in block 308 of FIG. 3, the apparatus 20 embodied by the computing device 10 may be configured to receive a Medium Access Control (MAC) command comprising information related to an allow/disallowance of UL communication enablement/disablement or reduction. The apparatus embodied by the computing device therefore includes means, such as the processor 22, the communication interface 26 or the like, for receiving a Medium Access Control (MAC) command comprising information related to an allowance/disallowance of UL communication enablement/disablement or reduction. In one embodiment, a time period may be specified when the reduction of UL transmissions is applied. In another embodiment, a time period may be specified when no reduction is allowed if, for example, a default configuration is reduced UL transmission.

In another embodiment, as shown in block 310 of FIG. 3, the apparatus 20 embodied by the computing device 10 may be configured to receive a trigger command comprising information related to an allowance/disallowance of UL communication, enablement/disablement, or reduction. The apparatus embodied by the computing device therefore includes means, such as the processor 22, the communication interface 26 or the like, for receiving a trigger command comprising information related to an allowance/disallowance of UL communication, enablement/disablement, or reduction. In one embodiment, a network may use separate triggers to command UE to send PUCCH UL when such a need is determined, e.g., when the network may assume new data coming. Such may be the procedure when the reduced UL transmission is a default option. Alternatively, the trigger may have a separate trigger when to apply reduced Uplink transmission (ULTX) if no data is determined to be coming, if for example, a default option is with non-reduced transmissions.

In another embodiment, a separate trigger may be utilized when reduced UL transmission is allowed. This may be related to Per-Packet-Information (PPI) indication of low power consumption. Although PPI is given as an example, other types of triggers may be utilized.

In one embodiment, similar UL TX reduction may be configured and/or used for all PUCCH transmission or, separately for the periodical transmissions like periodical CQI/PMI transmission or periodical RI transmission. This method may reduce unnecessary UL transmissions by the UE and thereby also reduce the UL interference by the UE. Furthermore, the network may gain better control of the usage of the periodic resources on PUCCH enabling better time division sharing of the UL resources among multiple UEs.

FIG. 4 is an example flowchart illustrating a method for reducing, such as by minimizing, UL transmissions in accordance with an embodiment of the present invention. As shown in block 402 of FIG. 4, the apparatus 20 embodied by the computing device 10 may therefore be configured to provide TA updates in on-duration. The apparatus embodied by the computing device therefore includes means, such as the processor 22, the communication interface 26 or the like, for providing TA updates in on-duration.

As shown in block 404 of FIG. 4, the apparatus 20 embodied by the computing device 10 may therefore be configured to receive UL transmissions from UE. The apparatus embodied by the computing device therefore includes means, such as the processor 22, the communication interface 26 or the like, for receiving UL transmissions from UE.

As shown in block 406 of FIG. 4, the apparatus 20 embodied by the computing device 10 may therefore be configured to provide a Radio Resource Control (RRC) message to configure a Physical Uplink Control Channel (PUCCH) where Uplink (UL) is enabled or disabled, with optional timing instructions. The apparatus embodied by the computing device therefore includes means, such as the processor 22, the communication interface 26 or the like, for providing a Radio Resource Control (RRC) message to configure a Physical Uplink Control Channel (PUCCH) where Uplink (UL) is enabled or disabled, with optional timing instructions.

As shown in block 408 of FIG. 4, the apparatus 20 embodied by the computing device 10 may therefore be configured to provide a Medium Access Control (MAC) command comprising information related to an allowance/disallowance of UL communication enablement/disablement or reduction. The apparatus embodied by the computing device therefore includes means, such as the processor 22, the communication interface 26 or the like, for providing a Medium Access Control (MAC) command comprising information related to an allowance/disallowance of UL communication enablement/disablement or reduction.

As shown in block 410 of FIG. 4, the apparatus 20 embodied by the computing device 10 may therefore be configured to provide a trigger command comprising information related to an allowance/disallowance of UL communication enablement/disablement or reduction. The apparatus embodied by the computing device therefore includes means, such as the processor 22, the communication interface 26 or the like, for providing a trigger command comprising information related to an allowance/disallowance of UL communication enablement/disablement or reduction.

In accordance with one embodiment of the present invention, a method may be provided comprising causing operation of use equipment in a uplink synchronized state, wherein updates are received periodically in a on duration period, on duration periods are related to discontinuous reception (DRX) short cycle timer, receiving instruction to disable uplink transmission during one or more on duration periods related to short cycle timer of DRX, and causing disablement of uplink transmission in accordance with instruction.

In one embodiment, instruction may comprise a Radio Resource Control (RRC) message to configure a Physical Uplink Control Channel (PUCCH) where Uplink (UL) is enabled or disabled. In another embodiment, instruction may comprise a Medium Access Control (MAC) command comprising information related to an allowance or disallowance of UL communication disablement or reduction. In another embodiment, instruction may comprise a trigger command comprising information related to an allowance or disallowance of UL communication disablement or reduction. In one embodiment, instruction may comprise causing enabling or disabling of UL communication in a time limited manner. In one embodiment, a timer value shall be configured. In another embodiment, a timer value or time period can be fixed and defined in the specifications.

In accordance with another example embodiment of the present invention, an apparatus may be provided. The apparatus may comprise at least one processor and at least one memory including computer program code, the at least one memory and the computer program code configured to, with the processor, cause the apparatus to at least cause operation of use equipment in a uplink synchronized state, wherein updates are received periodically in a on duration period, on duration periods are related to discontinuous reception (DRX) short cycle timer, receive instruction to disable uplink transmission during one or more on duration periods related to short cycle timer of DRX, and cause disablement of uplink transmission in accordance with instruction.

In one embodiment, instruction may comprise a Radio Resource Control (RRC) message to configure a Physical Uplink Control Channel (PUCCH) where Uplink (UL) is enabled or disabled. In another embodiment, instruction may comprise a Medium Access Control (MAC) command comprising information related to an allowance or disallowance of UL communication disablement or reduction. In another embodiment, instruction may comprise a trigger command comprising information related to an allowance or disallowance of UL communication disablement or reduction. In one embodiment, instruction may comprise causing enabling or disabling of UL communication in a time limited manner. In one embodiment, a timer value shall be configured. In another embodiment, a timer value or time period can be fixed and defined in the specifications.

In accordance with another embodiment of the present invention, a computer program product may be provided. The computer program product may comprise at least one non-transitory computer-readable storage medium having computer-executable program code portions stored therein, the computer-executable program code portions comprising program code instructions for causing operation of use equipment in a uplink synchronized state, wherein updates are received periodically in a on duration period, on duration periods are related to discontinuous reception (DRX) short cycle timer, receiving instruction to disable uplink transmission during one or more on duration periods related to short cycle timer of DRX, and causing disablement of uplink transmission in accordance with instruction.

In one embodiment, instruction may comprise a Radio Resource Control (RRC) message to configure a Physical Uplink Control Channel (PUCCH) where Uplink (UL) is enabled or disabled. In another embodiment, instruction may comprise a Medium Access Control (MAC) command comprising information related to an allowance or disallowance of UL communication disablement or reduction. In another embodiment, instruction may comprise a trigger command comprising information related to an allowance or disallowance of UL communication disablement or reduction. In one embodiment, instruction may comprise causing enabling or disabling of UL communication in a time limited manner. In one embodiment, a timer value shall be configured. In another embodiment, a timer value or time period can be fixed and defined in the specifications.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-21. (canceled)

22. A method comprising:
causing operation of user equipment in a uplink synchronized state,
wherein updates are received periodically in a on duration period, on duration periods being related to a discontinuous reception (DRX) short cycle timer;
receiving an instruction to disable uplink transmission during one or more on duration periods related to the short cycle timer of DRX; and
causing disablement of uplink transmission in accordance with the instruction.

23. The method of claim 22, wherein the instruction comprises a Radio Resource Control (RRC) message to configure a Physical Uplink Control Channel (PUCCH) wherein Uplink (UL) is enabled or disabled.

24. The method of claim 22, wherein the instruction comprises a Medium Access Control (MAC) command comprising information related to an allowance or disallowance of UL communication disablement or reduction.

25. The method of claim 22, wherein the instruction comprises a trigger command comprising information related to an allowance or disallowance of UL communication disablement or reduction.

26. The method of claim 22, wherein the instruction comprises causing enabling or disabling of UL communication in a time limited manner.

27. The method of claim 22, wherein a timer value is configured.

28. The method of claim 22 wherein a timer value or time period is fixed and defined.

29. An apparatus comprising at least one processor and at least one memory including computer program code, the at least one memory and the computer program code configured to, with the processor, cause the apparatus to at least:
cause operation in a uplink synchronized state,
wherein updates are received periodically in a on duration period, on duration periods are related to discontinuous reception (DRX) short cycle timer;
receive instruction to disable uplink transmission during one or more on duration periods related to short cycle timer of DRX; and
cause disablement of uplink transmission in accordance with instruction.

30. The apparatus of claim 29, wherein the instruction comprises a Radio Resource Control (RRC) message to configure a Physical Uplink Control Channel (PUCCH) wherein Uplink (UL) is enabled or disabled.

31. The apparatus of claim 29, wherein the instruction comprises a Medium Access Control (MAC) command comprising information related to an allowance or disallowance of UL communication disablement or reduction.

32. The apparatus of claim 29, wherein the instruction comprises a trigger command comprising information related to an allowance or disallowance of UL communication disablement or reduction.

33. The apparatus of claim 29, wherein the instruction comprises causing enabling or disabling of UL communication in a time limited manner.

34. The apparatus of claim 29, wherein a timer value is configured.

35. The apparatus of claim 29, wherein a timer value or time period is fixed and defined.

36. A computer program comprising at least one non-transitory computer-readable storage medium having computer-executable program code portions stored therein, the computer-executable program code portions comprising program code instructions for:
causing operation of a user equipment in a uplink synchronized state, wherein updates are received periodically in a on duration period, on duration periods are related to discontinuous reception (DRX) short cycle timer;
receiving instruction to disable uplink transmission during one or more on duration periods related to short cycle timer of DRX; and
causing disablement of uplink transmission in accordance with instruction.

37. The computer program product according to claim 36, wherein the instruction comprises a Radio Resource Control (RRC) message to configure a Physical Uplink Control Channel (PUCCH) where Uplink (UL) is enabled or disabled.

38. The computer program product according to claim 36, wherein the instruction comprises a Medium Access Control (MAC) command comprising information related to an allowance or disallowance of UL communication disablement or reduction.

39. The computer program product according to claim 36, wherein the instruction comprises a trigger command comprising information related to an allowance or disallowance of UL communication disablement or reduction.

40. The computer program product according to claim 36, wherein the instruction comprises causing enabling or disabling of UL communication in a time limited manner.

41. The computer program product according to claim 36, wherein a timer value is configured.
